(19) United States
(12) Patent Application Publication
(10) Pub. No.: US 2019/0126508 A1
(43) Pub. Date: May 2, 2019

(54) METHOD OF MANUFACTURING GLUE LAMINATED TIMBER COLUMNS

(71) Applicant: STRUCTURLAM MASS TIMBER CORPORATION, Penticton (CA)

(72) Inventor: Andre MORF, Penticton (CA)

(21) Appl. No.: 16/172,064

(22) Filed: Oct. 26, 2018

(30) Foreign Application Priority Data
Oct. 27, 2017 (CA) 2984079

(51) Int. Cl. B27M 3/00; B27M 1/02; B27M 1/08

(52) U.S. Cl. CPC B27M 3/0053; B27M 1/08; B27M 1/02; B27M 3/0086

(57) ABSTRACT

A method of manufacturing glue laminated timber columns involves forming a glue laminated timber panel and then cutting the glue laminated timber panel into a selected number of glue laminated timber columns. The method provides a substantial saving compared to a custom mass timber column.

### FIELD

There is described a method of manufacturing glue laminated timber columns.

### BACKGROUND

Wikipedia has the following commentary on glue laminated timber.

“Glued laminated timber, also called glulam, is a type of structural engineered wood product comprising a number of layers of dimensioned lumber bonded together with durable, moisture-resistant structural adhesives. In North America the material providing the laminations is termed laminating stock or lamstock. By laminating a number of smaller pieces of lumber, a single large, strong, structural member is manufactured from smaller pieces. These structural members are used as vertical columns or horizontal beams, as well as curved, arched shapes. Glulam is readily produced in curved shapes and it is available in a range of species and appearance characteristics to meet varied end-use requirements. Connections are usually made with bolts or plain steel dowels and steel plates. Glulam optimizes the structural values of a renewable resource—wood. Because of their composition, large glulam members can be manufactured from a variety of smaller trees harvested from second- and third-growth forests and plantations. Glulam provides the strength and versatility of large wood members without relying on the old growth-dependent solid-sawn timbers. As with other engineered wood products, it reduces the overall amount of wood used when compared to solid sawn timbers by diminishing the negative impact of knots and other small defects in each component board. Glulam has much lower embodied energy than reinforced concrete and steel, although of course it does entail more embodied energy than solid timber. However, the laminating process allows timber to be used for much longer spans, heavier loads, and complex shapes. Glulam is two-thirds the weight of steel and one sixth the weight of concrete—the embodied energy to produce it is six times less than the same suitable strength of steel. Glulam can be manufactured to a variety of straight and curved configurations so it offers architects artistic freedom without sacrificing structural requirements.”

### SUMMARY

According to one aspect, there is provided a method of manufacturing glue laminated timber columns. In broad terms the method involves forming a glue laminated timber panel as an intermediate step and then cutting the glue laminated timber panel into a selected number of glue laminated timber columns.

According to another aspect, there is a glue laminated timber column made in accordance with the teaching of the method.

The industry is presently doing a custom lay-up for each column manufactured. The method described above, therefore, is a radical departure from industry practices. This enables a dramatic reduction in cost. In addition, the method enables a dramatic increase in the speed with which order can be filled. A plurality of standard glue laminated timber panels can be prepared in advance. As orders are received, the glue laminated timber panels can be rapidly cut to create glue laminated timber columns that meet customer's requirements, with the columns ready for shipment on the same date the order was received.

The adoption of this method has enabled further measures to be taken to reduce cost. The industry practice is to make columns from very high grade and high cost Douglas fir lumber. When Spruce-pine-fir (SPF) lumber is used, the costs are further reduced. As the SPF2100 MSR lumber is a machine stress-rated (MSR) lumber, this substitution can be made while still meeting engineering specifications.

The adhesives currently used in the making of glue laminated timber columns are resorcinol and melamine adhesives. It is preferred that polyurethane adhesives be used. The use of polyurethane adhesives are preferred because they provide the following advantages: they are fast glue curing, require less pressure and are more environmentally friendly.

When the innovation in manufacture is combined with the innovation in the use of polyurethane adhesives and the use of lower cost fibre, the end result is a glue laminated timber column that is significantly lower in cost as compared to a custom glue laminated timber column fabricated by previously known methods.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view of a glue laminated timber panel constructed as an intermediate step in the formation of glue laminated timber columns.

FIG. 2 is a detailed end elevation view of the glue laminated timber panel illustrated in FIG. 1.

FIG. 3 is an end elevation view of the glue laminated timber panel, showing cuts made to create glue laminated timber columns.

FIG. 4 is a perspective view of a glue laminated timber column.

FIG. 5 is a side elevation view of a finger jointed length of board from the glue laminated timber panel.

### DETAILED DESCRIPTION

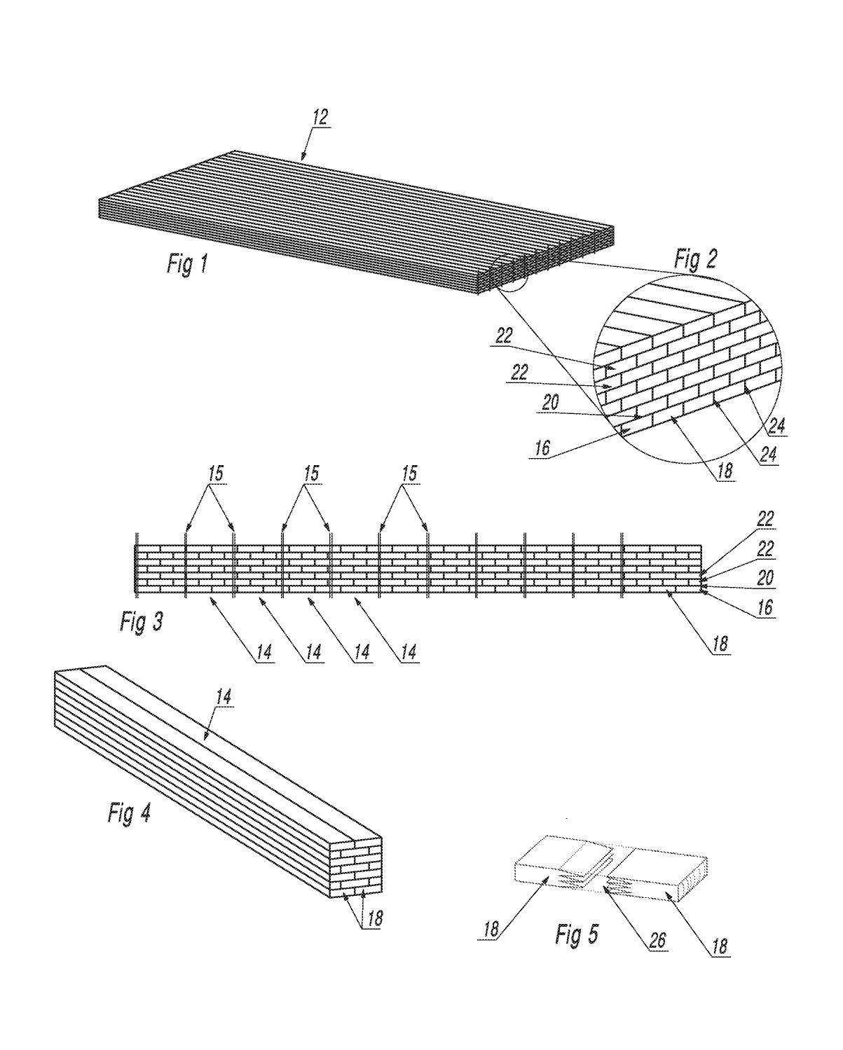

A method of manufacturing glue laminated timber columns will now be described with reference to FIG. 1 through 5.

### Method:

Referring to FIG. 1, the method involves forming a glue laminated timber panel 12 as an intermediate step. Referring to FIG. 3, the method then involves cutting the glue laminated timber panel 12 into a selected number of glue laminated timber columns 14, as shown in FIG. 4. Referring to FIG. 3, cut lines 15 show where cuts have been made to form glue laminated timber columns 14. Any suitable cutting machine may be used. The Applicant has used computer numeric controller (CNC) cutting equipment.

Referring to FIG. 2, the manner that glue laminated timber panel 12 is laid out is illustrated. Glue laminated timber panel is formed by laying out a lower or first layer 16 of boards 18. A layer of glue 20 is applied to first layer 16 of boards 18 in preparation for addition of a subsequent layer 22 of boards 18. Sequentially, each subsequent layer 22 of boards 18 is laid out and another layer of glue 20 applied in preparation for another of each subsequent layer 22 of boards 18 being added. This is continued until a multiple layered assembly is created of a selected number of layers of boards. The multiple layered assembly is then pressed until the glue is cured and glue laminated timber panel 12 has been formed. The preferred type of press is a cross-laminated timber (CLT) press which is capable of pressing the multiple layered assembly in both y and z directions.

Referring to FIG. 2, it can be seen that first layer 16 of boards 18 and each subsequent layer 22 of boards 18 run lengthwise in glue laminated timber panel. Referring to FIG. 3 and FIG. 4, it is preferred that glue laminated timber panel 12 be cut lengthwise in the same orientation of boards 18 to form the glue laminated timber columns. Referring to FIG. 2, it is preferred that joints 24 between subsequent layers 22 of boards 18 be staggered. This staggering is preferably by approximately one half of a width of each board 18.

While the method could be used with high quality Douglas Fir lumber, in order to minimize cost, it is preferred that the boards 18 used are a spruce-pine-fir (SPF2100MSR) lumber. SPF2100MSR is a machine stress-rated (MSR) lumber and can be substituted while still meeting engineering specifications. While the method could be used with any suitable adhesive, it is preferred that the glue used to fabricate the glue laminated timber panel be a polyurethane adhesive. The polyurethane adhesive provides the following advantages: they are fast glue curing, require less pressure and are more environmentally friendly.

While the method could be used with boards 18 of different dimensions, beneficial results have been obtained by the applicant using with 2×6 lumber. Boards 18 are planned prior to use to provide consistent dimensions. After planning each of the boards is 35 mm (1⅜ inches) thick and 133 mm (5.25 inches) in width.

The cross-laminated timber (CLT) press used by the applicant can accommodate a width of 10 feet. However, care must be taken to allow room for pressing. In the result a glue laminated timber panel approximately 8 feet in width is preferred. The cross-laminated timber (CLT) press used by the applicant glue laminated timber panel can be of any length up to 40 feet. Referring to FIG. 5, the boards 18 used to fabricate glue laminated timber panel 12 are finger-jointed, as generally indicate by reference numeral 26, in end to end relation to achieve a selected length. The cross-laminated timber (CLT) press used by the applicant can accommodate first layer 16 of boards 18 and up to 10 subsequent layers 22 of boards 18 for a total of up to 11 layers.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. A method of manufacturing glue laminated timber columns, comprising:
forming a glue laminated timber panel; and
cutting the glue laminated timber panel into a selected number of glue laminated timber columns.

2. The method of claim 1, wherein boards used to fabricate the glue laminated timber panel is machine stress-rated (MSR) lumber.

3. The method of claim 2, wherein the MSR lumber is a spruce-pine-fir (SPF) lumber.

4. The method of claim 1, wherein the glue used to fabricate the glue laminated timber panel is a polyurethane adhesive.

5. The method of claim 1, with the glue laminated timber panel being formed by:
laying out a first layer of boards;
applying glue to the first layer of boards in preparation for addition of a subsequent layer of boards;
laying out sequentially each subsequent layer of boards and applying glue in preparation for each subsequent layer of boards being added until a multiple layered assembly is created of a selected number of layers of boards;
pressing the multiple layered assembly until the glue is cured and the glue laminated timber panel has been formed.

6. The method of claim 5, wherein the multiple layered assembly is pressed in both y and z directions.

7. The method of claim 6, wherein a cross-laminated timber (CLT) press is used.

8. The method of claim 5, wherein the first layer of board and each subsequent layer of board runs lengthwise and the glue laminated timber panel is cut lengthwise to form the glue laminated timber columns.

9. The method of claim 5, wherein joints between subsequent layers of boards are staggered.

10. The method of claim 9, wherein the joints are staggered by approximately one half of a width of each board.

11. The method of claim 5, wherein each of the boards is 35 mm (1⅜ inches) thick.

12. The method of claim 5, wherein each of board is 133 mm (5.25 inches) in width.

13. The method of claim 1, wherein the glue laminated timber panel is approximately 8 feet wide and a length of up to 40 feet.

14. The method of claim 13, wherein boards used to fabricate the glue laminated timber panel are finger-jointed in end to end relation to achieve a selected length.

15. The method of claim 5, wherein there are up to 10 subsequent layers of boards for a total of up to 11 layers.

16. Glue laminated timber columns made by the method of claim 1.
